(19) United States
(12) Patent Application Publication
(10) Pub. No.: US 2024/0075612 A1
(43) Pub. Date: Mar. 7, 2024

(54) MODULAR MOTOR UNITS AND METHODS FOR MAKING THE SAME FOR ACTIVE-PASSIVE ROBOTIC EXOSKELETON SYSTEMS

(71) Applicant: Motion Augmented LLC, Farmington Hills, MI (US)

(72) Inventors: Cameron Brandon Pinnock, Farmington, MI (US); Haroun Algahmi, Detroit, MI (US)

(73) Assignee: Motion Augmented LLC, Farmington Hills, MI (US)

(21) Appl. No.: 18/160,356

(22) Filed: Jan. 27, 2023

Related U.S. Application Data
(60) Provisional application No. 63/403,425, filed on Sep. 2, 2022.
(60) Provisional application No. 63/418,135, filed on Oct. 21, 2022.

(51) Int. Cl. B25J 9/00

(52) U.S. Cl. CPC B25J 9/0006; A61G 2203/10; A61H 2201/1207

(57) ABSTRACT

A modular passive-to-active exoskeleton system utilizes motor unit modules, an electromagnetic clutch power transmission system, and biometric control. The passive exoskeleton has a stamina-increasing “chair less chair” function, and optional use of magnetic ball and socket joints and knee torsion springs. To convert the exoskeleton system into an active robotic wearable device, modular attachments allow for motor units to be securely connected to the exoskeletal unit. This exoskeleton contains a knee motor unit that has a transmission system with an electromagnetic clutch that enables a passive mode, active mode, and/or hybrid mode. The motor units are controlled via wireless biometric motion sensors that measure limb joint angle and muscle activity. These motor units also communicate via wireless transmission with a central processing units of the exoskeleton. This central processing unit serves as a gateway for user feedback from an Internet-of-Things (IoT) device, such as a smart phone, tablet, or computer.

### CLAIM OF PRIORITY AND CROSS-REFERENCE TO RELATED APPLICATIONS

This application claims the benefit of and priority to U.S. Provisional Patent Application No. 63/403,425, which was filed on Sep. 2, 2022, and U.S. Provisional Patent Application No. 63/418,135, which was filed on Oct. 21, 2022, both of which are incorporated herein by reference in their respective entireties and for all purposes.

### TECHNICAL FIELD

The present disclosure relates generally to wearable devices and systems for assisting with user motion. More specifically, aspects of this disclosure relate to passive and active exoskeleton systems for assisting human motion and reducing energy expenditure during motion.

### BACKGROUND

Many exoskeletons on the market are used in medical rehabilitation and industrial applications that require heavy lifting or other atypical dynamic movements. The exoskeletons in both of these applications typically do not incorporate features that allow the wearers to use their own natural strength while healing or to quickly escape from danger while on the job. Even though a reason for using exoskeletons in this manner is to assist the wearer, the user may eventually wish to rely on their own strength without supplemental assistance, e.g., via an exoskeletal electric motor. Many applications may be directed to rehabilitation of minor injuries and for uninjured individuals that are using the exoskeleton system to conserve energy while doing tasks. In such applications, having the ability to walk or lift with assistance via a motor and, when desired, run or move freely without motor-assistance may be crucial in the engineering of an exoskeleton suit.

Exoskeletons may be controlled using a variety of different methods. For instance, an exoskeleton may be controlled autonomously via computer programmed software (e.g., in instances where the user is paralyzed from the waist down). Another method includes using walking sticks that have force sensors or motion sensors that work in cadence with the exoskeleton robot. In an example, electromyography (EMG) and electroencephalograph (EEG) sensors may be employed to control the exoskeleton systems (e.g., for users that are partially or completely paralyzed from the waist down). Additionally, motion sensors may be employed to measure joint angles to aid in providing direction for the exoskeleton. Available types of biometric sensors that may be utilized in exoskeleton systems include, for example, motion joint angle sensors worn on the user's body, force sensors worn on the hands and feet, EMG sensors, and EEG sensors. However, many commercially available biometric sensors are costly, cumbersome, and/or contain many wires that complicate system assembly and can be inconvenient for the end user.

Exoskeleton technology has been in use experimentally since the mid-20th century and has since gained much traction. An example of a “Reconfigurable Exoskeleton” is presented in U.S. Patent App. Pub. No. 2015/0351995 A1, to Adam Zoss et al., which utilizes a modular joint system to enable reconfigurable exoskeleton limbs. The Zoss exoskeleton is a powered exoskeleton system that allows for limb actuation at the joints for assistance during walking. Even though this device is less bulky than many other available exoskeletons, it moves slowly and is only meant for rehabilitation purposes for individuals with lower extremity paralysis. Users are not able to run with the Zoss exoskeleton nor are they able to move with the system power off.

An example of a “Motorized Exoskeleton Unit” is shown in U.S. Patent App. Pub. No. 2013/0253385 A1, to Amit Goffer et al., which is designed for a lower body extremity. The exoskeleton's joints are motorized to allow for actuation of the limbs. Goffer's device is designed to assist someone while walking and for related biped locomotion. In addition, this device contains a motor that is only connected to a lower limb and does not contain a clutching mechanism to allow the individual the freedom to move on their own.

An example of a robotic “Wearing-Type Movement Assistance Device” is shown in U.S. Patent App. Pub. No. 2017/0144309 A1, to Sankai, which uses drive units to provision lift assistance using angle joint sensors to control the exoskeleton. Sankai's exoskeleton includes an upper limb assistance section jointed to a lower limb assistance section with motorized hip, shoulder, and elbow joints to aid someone while performing tasks. However, the exoskeleton drive motors are permanent fixtures and, thus, are not readily attachable and removable by the end user. In addition, Sankai's sensors are not wireless and the exoskeleton system is not modular.

None of the above-described exoskeleton examples are hybrid passive-and-active robotic exoskeletons in which the end user can readily add and remove motor units or selectively engage and disengage the motor units when desired. Additionally, none of the above motorized exoskeleton examples utilize a clutch device for the selective transmission of power from the motor to actuate a limb to enhance the user's strength, nor are they being controlled via wireless sensor technology. All of the above discussed U.S. patents and patent Application Publications are incorporated herein by reference in their respective entireties and for all purposes.

### SUMMARY

Presented herein are exoskeleton systems with attendant control logic for assisting users with movement, power clutch transmissions for exoskeletons, modular motor units for exoskeletons, wireless biometric controls systems for exoskeletons, and methods for making and methods for operating disclosed exoskeletons, transmissions, motor units, and/or biometric systems. In an example, there is presented a modular exoskeleton adaptable with modular motor unit attachments that increase a user's strength when electrically powered. When not powered, the exoskeleton is in a passive mode that allows the user to freely move without assistance. The user can detach the motor units and customize the passive exoskeleton to multiple different architectures. Disclosed exoskeleton systems may employ Internet of Things (IoT) technology, e.g., that uses Bluetooth Low Energy technology (BLE), to connect biometric sensors to a central processing unit (CPU) of the exoskeleton and, if desired, to other resident system devices.

Aspects of this disclosure are also directed to hybrid power clutch transmission devices, e.g., for an elbow/knee motor unit, a hip/shoulder motor unit, and/or other motorized limb units of an exoskeleton system. The hybrid transmission and attendant control scheme is enabled via one or more electromagnetic clutches that engage and take up torque capacity when powered to thereby initiate a strength-enhancing active operating mode of the exoskeleton system. When not powered, the electromagnetic clutch or clutches disengage and slip to enable a passive operating mode of the exoskeleton system. An optional hybrid operating mode may default to a passive-type operating mode and automatically trigger an active-type operating mode when wireless biometric sensors activate clutch engagement when increased muscle activity is sensed.

The weight-bearing structure of the exoskeleton system may include an exoskeleton frame, which may contain an upper body mechanical structure and/or a lower body mechanical structure. The exoskeleton frame may use high-strength magnetic ball and socket joints for the hip and shoulder joint regions, e.g., to increase range of motion via mimicking the same regions of the human body. A knee region of the exoskeleton frame structure may be spring loaded, e.g., via a torsion spring and/or a gas spring. A leg region of the exoskeleton frame structure may contain a magnetic sliding lock mechanism that can be used to lock a gas spring when disengaged; when engaged, the sliding lock mechanism may unlock the gas spring such that the user can bend their knee. The sliding lock mechanism may allow the wearer to hold a desired position without the associated motor(s) being powered.

The exoskeleton frame structure may be made active, at least in part, via the attachment of one or more computer-controlled motor units. When powered on, these motor units supplement user strength for the wearer of the exoskeleton system. Output of the motorized units may be governed by a system central processing unit (CPU) based on feedback from a distributed network of wireless biometric sensors. Biometric sensors that are used to control the exoskeleton system may include motion sensors for detecting angle positioning and EMG sensors for detecting muscle activity. A modular exoskeleton architecture that is designed to add one or more motor unit modules to enable an active robotic exoskeleton provides multiple uses for the wearer as well as various economic benefits. When set in a passive operating mode, the exoskeleton frame structure may provide the user with the ability to stand or hold a squatting position, e.g., via mechanically locking parts of the exoskeleton. When set in an active operating mode, a user can add one or more motor units to aid in augmenting the wearer's strength capabilities. This enables a user to purchase/integrate only what is needed, and to modify the exoskeletal functionality at any time, rather than being limited to buying/using either a passive exoskeleton or a robotic exoskeleton.

Disclosed motorized exoskeleton systems may contain one or more knee modules that are each equipped with an electromagnetic clutch, e.g., for safety, increased freedom of movement, and decreased battery power consumption. Safety is a top priority for many applications when designing exoskeletons. For instance, the user will be protected from injury if a CPU error occurs because the system is able to decouple the motor from the limb. Also, the motor and the gears will be protected from damage if an error occurs. Increased freedom of movement may enable improved safety since disengaging the electromagnetic clutch or clutches enables the user to move without hinderance at their own speed and under their own control, e.g., to escape danger or to work faster. Unlike many commercially available motorized exoskeletons, in which the user can only move as fast as the exoskeleton motor allows them to move, disclosed exoskeleton systems help to enable both active and passive operation for unencumbered movement. Moreover, the ability to drivingly decouple the motor units reduces motor use including attendant energy consumption and wear; in so doing, the user can activate the exoskeleton systems assisted walking and lifting features when desired.

Attendant advantages for at least some of the disclosed concepts include modular motor unit designs that are structurally configured to be easily attached to an exoskeleton suit, providing an active exoskeleton architecture that enables enhanced strength via robotic actuation. At the same time, disclosed modular motor units are structurally configured to be easily detached from an exoskeleton suit, providing a passive exoskeleton architecture that enables the user to rely on their own strength and stamina, e.g., with the enhanced stability provided by the suit. To simplify motor attachment/detachment while reducing system cost, weight, and complexity, disclosed motor units may communicate wirelessly with on-board controllers and sensors. The modularity and interchangeability of the motor modules further reduces system complexity and manufacturing costs while optimizing cross-platform adaptability and improving end-user experience.

Aspects of this disclosure are directed to modular motor units for exoskeleton systems, including a full-body or partial-body exoskeleton (“exo”) frame with one or more joint assemblies that each attaches to an appendage of a user. In an example, a motor unit is composed of a motor support structure that is defined, at least in part, by a first motor plate that is fastened, welded, integrally formed, jointed, or otherwise rigidly attached to/with a second motor plate. The first motor plate removably mounts to a joint assembly of an exoskeleton frame. An electric motor is mounted to the second motor plate and selectively produces a motor output torque at a motor output speed, e.g., to boost or automate articulating movement of the joint assembly. Drivingly connected to the electric motor is a harmonic drive unit that selectively modifies the motor output speed and the motor output torque of the electric motor. A motor attachment device, which is drivingly connected to the harmonic drive unit, drivingly connects the motor and drive unit to the joint assembly and thereby transmits to the joint assembly the modified motor torque at the modified motor speed output from the harmonic drive unit. Unlike most traditional gear-reduction boxes, which employ rigid, circular gears, a harmonic drive unit uses a flexible “spline” gear that is driven by an elliptical, toothless “plug” cam that receives torque output from the motor.

Additional aspects of this disclosure are directed to hybrid active-passive exoskeleton systems for assisting the movement of a user. As used herein, the terms “exoskeleton” and “exoskeleton system”, including permutations thereof, may be used interchangeably and synonymously to include any relevant exoskeleton platform, such as: medical exoskeletons, industrial exoskeletons, and combat exoskeletons; passive-type, active-type, and hybrid-type exoskeletons; fixed architectures, supported architectures, and mobile architectures; soft-suit and hard-suite designs; and full-body, lower-extremity, and upper-extremity exoskeletons, etc. In an example, an exoskeleton system includes an exoskeleton frame with at least one joint assembly that attaches to an appendage of a user.

Continuing with the preceding discussion, the exoskeleton system also includes one or more motor units that removably attach to the exoskeleton system's joint assembly/assemblies. Each motor unit includes a motor support structure with a first motor plate that is rigidly attached, either directly or indirectly, to a second motor plate. The first motor plate is removably mounted to a joint assembly of the exoskeleton frame. At least one electric motor is mounted to the second motor plate and operable to produce a motor output torque at a motor output speed. Drivingly connected to each electric motor is a harmonic drive unit that is operable to modify the motor output speed and the motor output torque of the electric motor. A motor attachment plate is drivingly connected to the harmonic drive unit, i.e., to rotate in unison with an output member thereof, and removably drivingly connected to the joint assembly. The motor attachment plate transmits the modified motor torque at the modified motor speed output from the harmonic drive unit to the joint assembly.

Aspects of this disclosure are also directed to manufacturing workflow processes, computer-readable media, and control logic for making or for using any of the disclosed exoskeleton systems, modular motor unit assemblies, biometric sensor arrays, and/or other disclosed hardware and componentry. In an example, a method is presented for assembling a motor unit for an exoskeleton system. The exoskeleton system includes an exoskeleton frame with a joint assembly configured to attach to an appendage of a user. This representative method includes, in any order and in any combination with any of the above and below disclosed options and features: assembling a motor support structure including rigidly attaching a first motor plate to a second motor plate, the first motor plate being configured to mount to the joint assembly; mounting an electric motor to the second motor plate, the electric motor being operable to produce a motor output torque at a motor output speed; drivingly connecting a harmonic drive unit to the electric motor, the harmonic drive unit being operable to modify the motor output speed and the motor output torque of the electric motor; and drivingly connecting a motor attachment device to the harmonic drive unit, the motor attachment device being configured to drivingly connect to the joint assembly and thereby transmit thereto the modified motor output torque at the modified motor output speed from the harmonic drive unit.

For any of the disclosed systems, methods, and devices, the motor unit may also include a first gear that is drivingly connected to the harmonic drive unit, a second gear that is rotatably attached to the first motor plate and mated in tooth-to-tooth “meshing” engagement with the first gear, and a rotational position encoder that is operatively connected to the second gear and operable to determine therefrom a rotational position of the electric motor. As another option, the first gear may be interposed between and coaxial with the harmonic drive unit and the motor attachment device. The harmonic drive unit may be interposed between and coaxial with the first gear and the electric motor. As yet another option, the first gear may be a first spur gear or a first bevel gear, whereas the second gear may be a second spur gear or a second bevel gear. In yet another option, the first gear rotates on a first axis, whereas the second gear rotates on a second axis that is spaced from and either substantially orthogonal or substantially parallel to the first axis.

For any of the disclosed systems, methods, and devices, one or more motor plate reinforcement rails (also referred to herein as “ligaments”) may be rigidly attached to the motor support structure; these reinforcement rail(s) structurally join the first motor plate to the second motor plate. The motor unit may employ first and second L-shaped reinforcement rails, each of which has a respective first end that is rigidly attached to and abuts the first motor plate and a respective second end that is rigidly attached to and abuts the second motor plate. As another option, the motor unit may employ first and second zigzag-shaped reinforcement rails, each of which has a respective first end that is rigidly attached to and abuts the first motor plate and a respective second end that is rigidly attached to the second motor plate.

For any of the disclosed systems, methods, and devices, the electric motor, the harmonic drive unit, the first gear, and the motor attachment device are coaxial with one another on a first axis of rotation. In this regard, the second gear and the encoder may be coaxial with one another on a second axis or rotation that is spaced from the first axis. As yet another option, the motor support structure may include a third motor plate that is interposed between and rigidly attached to the first and second motor plates. In this instance, the first motor plate may be substantially parallel or substantially orthogonal to the second motor plate, whereas the third motor plate may be substantially orthogonal to the first motor plate and/or the second motor plate.

For any of the disclosed systems, methods, and devices, a motor unit housing may be rigidly attached to the motor support structure; the motor unit housing contains therein the electric motor and, if desired, the CPU and motor driver that cooperatively govern operation of the electric motor. As another option, the motor attachment device may include or, if desired, may consist essentially of a substantially flat plate that drivingly attaches to the harmonic drive unit via a first gear to rotate in unison with an output member of the harmonic drive unit. The substantially flat plate may contain a circular array of holes that receive threaded fasteners for operatively attaching the motor attachment plate and, thus, the electric motor and harmonic drive unit to the joint assembly of the exoskeleton.

The above Summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a front, perspective-view illustration of a representative full-body modular exoskeleton system without motor unit modules in accord with aspects of this disclosure.

FIG. 2 is a partially exploded, front perspective-view illustration of a representative full-body modular exoskeleton system with motor unit modules and connectors for mounting motor unit modules to the exoskeleton frame of FIG. 1 in accord with aspects of this disclosure.

FIG. 3 is a side, perspective-view illustration of a representative hip/shoulder motor unit module in accord with aspects of this disclosure.

FIG. 4 is a rear-view illustration of the representative hip/shoulder motor unit module of FIG. 3.

FIG. 5 is a plan-view illustration of the representative hip/shoulder motor unit module of FIG. 3 shown without the motor unit cover and gear shell.

FIG. 6 is a side, perspective-view illustration of the representative hip/shoulder motor unit module of FIG. 3 shown without the motor unit cover and gear shell.

FIG. 7 is a partially exploded, top perspective-view illustration of the representative hip/shoulder motor unit of FIG. 3 shown without the motor unit cover and gear shell.

FIG. 8 is a front, perspective-view illustration of a representative elbow/knee motor unit module in accord with aspects of this disclosure.

FIG. 9 is a rear, perspective-view illustration of the representative elbow/knee motor unit module of FIG. 8 shown without the motor unit cover and gear shell.

FIG. 10 is a plan-view illustration of the representative elbow/knee motor unit module of FIG. 8 shown without the motor unit cover and gear shell.

FIG. 11 is a partially exploded, top perspective-view illustration of the representative elbow/knee motor unit module of FIG. 8.

FIG. 12 is a schematic system diagram illustrating a representative wireless biometric sensor-to-motor unit control to central device connection method in accord with aspects of this disclosure.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as exemplifications of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example.

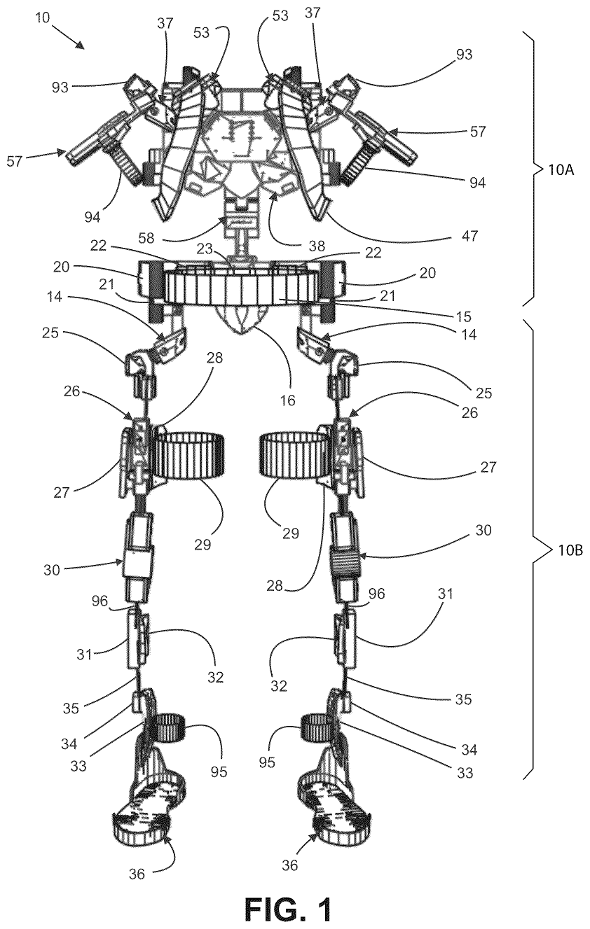

Referring now to the drawings, wherein like reference numbers refer to the same or similar features throughout the several views, there is shown in FIG. 1 a representative exoskeleton system, which is designated generally at 10 and portrayed herein for purposes of discussion as a modular, hybrid-type full-body exoskeleton structure for an “average” adult human. The illustrated full-body exoskeleton system 10—also referred to herein as “exoskeleton structure” or “exoskeleton” for short—is merely an exemplary application with which novel aspects of this disclosure may be practiced. As such, it will be understood that aspects and features of this disclosure may be implemented for any desired exoskeleton application (e.g., industrial, commercial, medicinal, combat, etc.), may be scaled and adapted for users of different sizes, shapes, and species, and may be incorporated into any logically relevant type of exoskeleton architecture (e.g., full-body, lower-extremity, upper-extremity, etc.). Moreover, only select components of the exoskeleton systems, motor units, and networked biometric sensors are shown and described in additional detail below. Nevertheless, the exoskeletons, motors, and sensors discussed herein may include numerous additional and alternative features, and other available peripheral components, for carrying out the various methods and functions of this disclosure.

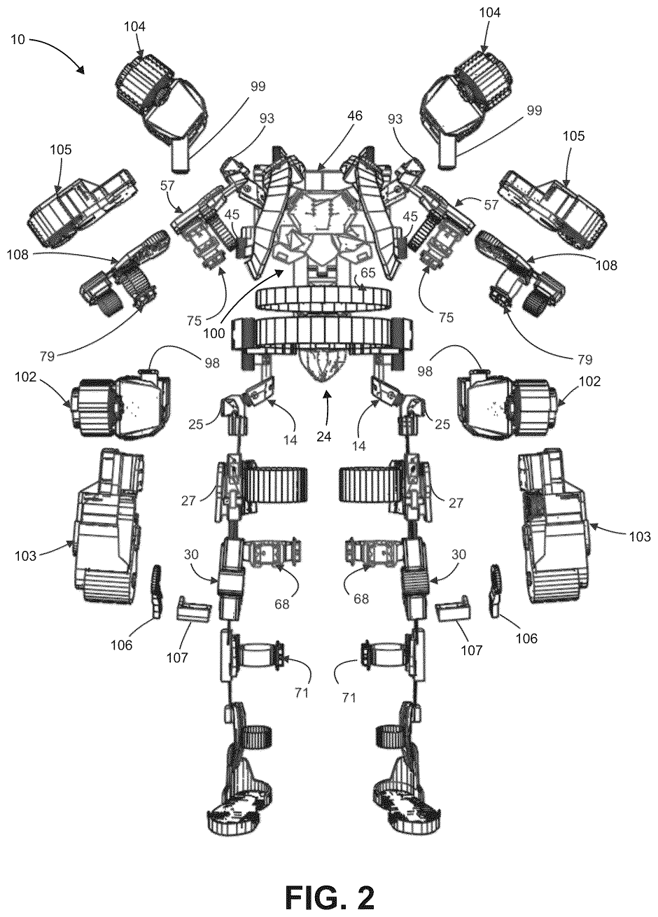

The exoskeleton system 10 of FIGS. 1 and 2 may be generally delineated into two interconnectable segments: (1) an upper extremity (first) frame section 10A, which generally extends from a waist-hip midpoint to the neck and physically mounts to the user's trunk region; and (2) a lower extremity (second) frame section 10B, which generally extends from the waist-hip midpoint to the ankles and physically mounts to the legs of a biped. The upper extremity frame section 10A of the exoskeleton system 10 is releasably joined via a hip assembly 14 to the lower extremity frame section 10B. With his arrangement, the exoskeleton system 10 may be readily modified (e.g., without specialized tools or permanently damaging the skeletal structure) for use of just the upper section 10A, just the lower section 10B, or both sections 10A, 10B. The hip assembly 14, in turn, is connected to an outer waist-hip beltloop shell 21, which includes a waist belt 15 that is looped through a central waist belt loop (not visible in the view provided) to secure the upper section 10A to the user's waist. A waist belt loop cover 22 is placed on top of the beltloop shell 21 to secure the waist belt 15; the beltloop shell 21 is then connected via a waist bracket C 20 to the hip assembly 14 and a spine unit assembly 58. A waist central unit and a waist bracket unit (not visible in this view) cooperate with waist bracket units 20 to create an adjustable waist support for the exoskeleton system 10.

A lower outer side region of the hip assembly 14 of FIGS. 1 and 2 connects to a pair of (left and right) exoskeleton hip motor adaptors 25, whereas a bottom region of each hip motor adaptor 25 connects to a respective (left or right) exoskeleton thigh assembly 26. An outer side region of each thigh assembly 26 is connected to a respective exoskeleton knee motor adaptor 27, whereas an inner side region of each thigh assembly 26 is connected to a respective femur outer shell 28. The left (first) and right (second) thigh assemblies 26 each employ a respective thigh strap 29 to releasably attach the thigh assemblies 26 and, thus, the lower extremity section 10B to the user's thighs/upper legs. Each thigh assembly 26 is connected to a respective tibial bracket connector 31 via a respective knee assembly 30 and a respective lower leg upper bracket 96. As will be described in further detail below, the two (left and right) knee assemblies 30 detachably mount thereto knee motor units for mechanization of the user's knee joints. An inner side region of each tibial bracket connector 31 is connected to a respective tibial outer shell 32 that may abut one of the user's tibias. An optional gas spring (not visible in the views provided) may connect the thigh assembly 26 to the knee assembly 30

Continuing with the discussion of the exoskeleton's lower extremity section 10B, the two (left and right) tibial bracket connectors 31 are each connected to a respective ankle outer shell 33 via a respective lower leg bracket 35. The two (left and right) lower leg brackets 35 are attached to the (left and right) ankle outer shells 33 via respective shin size adjusters 34. Inner side regions of the ankle outer shells 33 are provided with an ankle strap 95 that wrap around and to releasably attach the ankle outer shells 33 and, thus, the lower extremity section 10B to the user's ankles/lower legs. A bottom outer side region of each ankle outer shell 33 is attached to a respective exoskeleton foot outer shell 36, which seats thereon and operatively attaches to a user's foot/shoe/boot. The two (left and right) ankle outer shells 33 may articulate with respect to the tibial bracket connectors 31, the connectors 31 may articulate with respect to the thigh assemblies 26, and the assemblies 26 may articulate with respect to the hip assembles 14.

To securely attach and selectively detach the lower extremity section 10B to the upper extremity section 10A, e.g., for a “full body” exoskeleton architecture, the hip assembly 14 releasably attaches to a bottom end of the spine unit assembly 58 via a socket assembly 23 and a tailbone outer shell 16. This spine unit assembly 58 connects at an upper end thereof to a flexible back plate assembly 38, which may abut a wearer's thoracic region. Left and right flanks of the back plate assembly 38 of FIGS. 1 and 2 are provided with respective shoulder outer shell assemblies 53 that contact the user's shoulders. A respective shoulder harness 47 releasably attaches each shoulder assembly 53 and, thus, the back plate assembly 38 and upper extremity section 10A to the user's left and right shoulders/upper body. In this vein, the two (left and right) shoulder harnesses 47 and the two (left and right) shoulder outer shell assemblies 53 aid in keeping the back plate 38 attached to the user's back. An outer side region of each exoskeleton shoulder assembly 37 attaches to an exoskeleton shoulder motor adaptor 93 for attaching thereto a respective shoulder motor unit. The shoulder assemblies 37 also couple to upper arm bracket assemblies 57, each of which includes an upper arm strap 94 that wraps around and releasably attaches the shoulder assemblies 37 and, thus, the upper extremity section 10A to the user's upper arm regions.

To transform the unassisted, passive-type exoskeleton architecture of FIG. 1 to a motor-assisted, active-type exoskeleton architecture, FIG. 2 presents a perspective view illustration of the modular exoskeleton system 10 of FIG. 1 with a distributed array of motor unit modules that are detachably connected via complementary motor unit connectors to the various motor adaptor sections of the exoskeleton 10. In accord with the illustrated example, a pair of (right and left) hip motor unit modules 102 mount on and drivingly connect to the hip motor adaptors 25 on the lower extremity section 10B of exoskeleton 10. Each hip motor unit module 102 is equipped with a respective hip rotational bracket 98 that connects the motor unit 102 to the hip assembly 14. In so doing, the motor unit modules 102 are selectively actuable to boost and/or automate movement of the hip assemblies 14 and, thus, the hip joints of the user. A pair of (right and left) knee motor unit modules 103 mount on and drivingly connect to the knee motor adaptors 27 via knee motor unit brackets 106. Each knee motor unit module 103 and corresponding bracket 106 securely attach to their respective knee assembly 30 via a knee bracket alignment adaptor 107. In so doing, the motor unit modules 103 are selectively actuable to boost and/or automate movement of the knee assemblies 30 and, thus, the user's knee joints. When operated in unison, the motor unit modules 102, 103 may assist with gaited locomotion of a user as well as jumping, squatting, climbing, lifting, etc.

With continuing reference to FIG. 2, a pair of (left and right) shoulder motor unit modules 104 mount on and drivingly connect to the shoulder motor adaptors 93 on the upper extremity section 10A of the exoskeleton 10. Each shoulder motor unit 104 is equipped with a respective shoulder rotational bracket 99 that connects the motor unit 104 to a back shoulder unit 45 on the back plate assembly 38. In so doing, the motor unit modules 104 are selectively actuable to boost and/or automate movement of the exoskeleton shoulder assemblies 37 and, thus, the shoulder joint of the user. A pair of (left and right) elbow motor unit modules 105 mount on and drivingly connect complementary forearm attachment assemblies 108, which removably attaches to the user's forearms via straps (as shown), cables, harnesses, or any other suitable means of attachment. Each of the elbow motor unit modules 105 operatively attaches to a respective upper arm bracket assembly 57 on one of the exoskeleton shoulder assemblies 37. In so doing, the motor unit modules 105 are selectively actuable to boost and/or automate movement of the exoskeleton elbow assemblies and, thus, the elbow joint of the user. When operated in unison, the motor unit modules 104, 105 may assist with movement of the upper appendages, e.g., to facilitate lifting, throwing, carrying, gait-related arm swing, etc.

To govern individual and synchronized operation of the motor unit modules 102, 103, 104, 105, the exoskeleton system 10 may employ a distributed array of sensing devices for monitoring real-time or near real-time user variables and system characteristics. The sensing devices may include: (1) a waist biometric sensor assembly 65; (2) a pair of thigh biometric sensor assemblies 68; (3) a pair of lower leg biometric sensor assemblies 71; (4) a pair of upper arm biometric sensor assemblies 75; and (5) a pair of forearm biometric sensor assemblies 79. A rechargeable battery pack 100 is attached to the back of the back plate assembly 38 and operable to power the exoskeleton's various electronic components. A lower body subsystem CPU 24 provisions input/output (I/O) logic-controlled operation of the sensors, motors, etc., of the lower extremity section 10B, whereas an upper body subsystem CPU 46 provisions I/O logic-controlled operation of the sensors, motors, etc., of the upper extremity section 10A. As noted above, detachment of the upper and lower extremity sections 10A, 10B of the active-passive exoskeleton 10 from each other creates a stand-alone lower body active/passive exoskeleton unit and a stand-alone upper body active/passive exoskeleton unit that may be operated independently from each other. This allows the user to further customize use of the exoskeleton 10 to a myriad of distinct upper and lower body applications. Additional information about the contents, arrangement, and functionality of the exoskeleton system 10 may be found in U.S. Provisional Patent Application No. 63/403,425 (hereinafter “'425 application”).

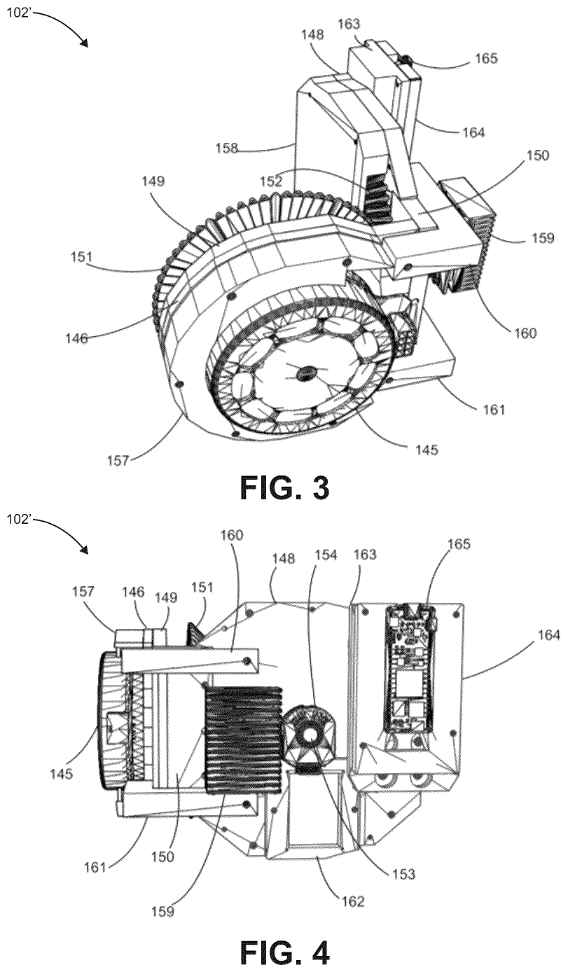

Turning next to FIG. 3, there is shown an example of a modular hip/shoulder motor unit 102′ that may be adapted for use as the hip motor unit modules 102 and/or the shoulder motor unit modules 104 of FIG. 2 (e.g., wherein left hip/shoulder motor units may be mirror images of right hip/shoulder motor units). In the illustrated example, the modular motor unit 102′ employs a first right-angle motor plate A 148 that is securely attached to a second right-angle motor plate B 149 to collectively define a foundational motor support structure onto which is mounted many of the motor unit's constituent internal parts. The first right-angle motor plate A 148 may be rigidly joined to the second right-angle motor plate B 149, for example, via machine screws fed through a third right-angle motor plate C 150 such that the first and second motor plates 148, 149 are substantially orthogonal to each other. It may be desirable that the first and second right-angle motor plates 148, 149 be made from a fiberglass reinforced plastic or other suitably resilient and light-weight material. To this end, it may be desirable that the third right-angle motor plate C 150 be made from steel or other metallic material to increase the durability and strength of the interconnected motor plates while reducing the overall weight of the motor module. A protective and weather-resistant outer housing, such as a motor cover and a gear shell (see, e.g., FIGS. 27 and 32 of '425 application), may cover the constituent parts of the hip/shoulder motor unit 102′.

An electric hip/shoulder motor 145, which may be in the nature of a brushless direct-current (DC) motor, is mounted onto a motor plate adaptor 146, e.g., via a series of circumferentially spaced machine screws; both the hip/shoulder motor 145 and motor plate adaptor 146 are secured to the second right-angle motor plate B 149. In this view, an electronic printed circuit board (PCB) package with heat sink and motor driver 159 controls a power feed to and a resultant variable speed of the hip/shoulder motor 145. The PCB package and motor driver 159 is mounted onto the first right-angle motor plate A 148, e.g., via threaded fasteners, and operatively connected to the motor 145, e.g., via electrical wires. A hip/shoulder motor unit CPU 165 is mounted via a CPU adaptor bracket 164 onto a microcontroller plate 163, which rigidly secures to the first right-angle motor plate A 148, e.g., via machine screws. The motor 145 and PCB/motor driver 159 are wired or wirelessly connected to and controlled by the hip/shoulder motor unit CPU 165 (e.g., to govern motor speed, torque, direction, fault protection, etc.). As shown, the hip/shoulder motor unit CPU 165 may be an integrated circuit PCB with at least a microcontroller and a wireless communications module (e.g., a BLUETOOTH® Low Energy (BLE) transceiver). Like the first and second right-angle motor plates 148, 149, the motor plate adaptor 146, microcontroller plate 163, and CPU adaptor 164 may be formed, in whole or in part, from a fiber reinforced polymer (FRP) material.

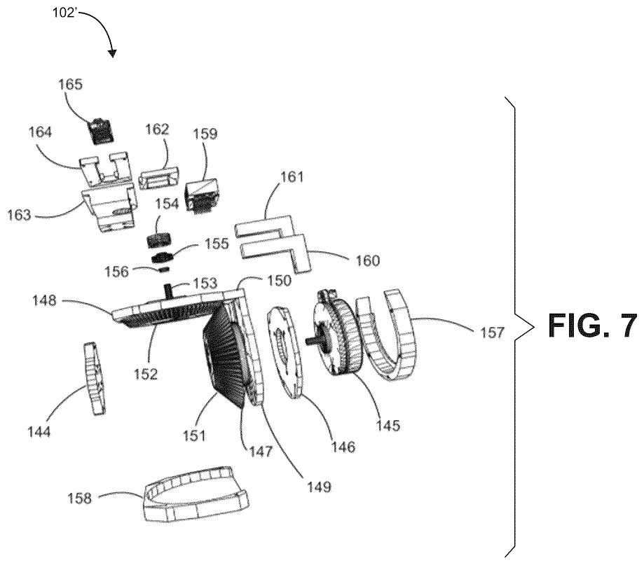

The motor unit's foundational support structure, namely the three interconnected motor plates 148, 149, and 150, may be structurally stabilized and reinforced via first and/or second (top and bottom) L-shaped motor plate rails (or “ligaments”) 160 and 161, which may rigidly attach to the first and second motor plates 149, 148 via threaded fasteners. Electrical wires that connect the hip/shoulder motor 145 to the PCB package and motor driver 159 may be concealed via a C-shaped motor wire channel cover 157. This motor wire channel cover 157 is shown circumscribing the motor 145 and rigidly attaching to the motor plate adaptor 146. Motor output and positional feedback for the hip/shoulder motor 145 is provided by a motor-driven position (first) bevel gear 151 and a gear-driven idle position (second) bevel gear 152. In the illustrated example, the first bevel gear 151 is coaxial with and drivingly connected to the motor 145, whereas the second bevel gear 152 is substantially orthogonal to and intermeshed with the first bevel gear 151. A direct splined coupling between an externally toothed motor shaft (FIG. 7) of the hip/shoulder motor 145 and an internally toothed gear hub of the driven bevel gear causes the gear 151 to rotate in unison with the motor 145. The intermeshed bevel gears 151, 152 may have distinct radii and gear teeth counts with an associated gear ratio that provides a predetermined mechanical advantage. The second bevel gear 152 may be covered via an FRP idle gear outer shell 158; the idle bevel gear 152 and outer shell 158 may be attached to the right-angle motor plate A 148.

FIG. 4 is a rear-view illustration of the representative motor unit 102′ of FIG. 2. This view shows an electronic PCB absolute position encoder 154 that functions as a position sensor for detecting a real-time rotational position of the hip/shoulder motor 145 via the gear-train coupling of the idle position bevel gear 152 with the motor-driven position bevel gear 151. The encoder 154 may be an electromechanical, optical, magnetic, or electromagnetic-induction type encoder that outputs electrical signals for close-loop feedback control. The absolute position encoder 154 is mounted on a rear face of the first right-angle motor plate A 148, interposed between the motor driver 159 and motor unit CPU 165. A position idle gear shaft 153 may be press fit, keyed, splined, or otherwise operatively connected to a complementary sensor bore hole in the absolute position encoder 154. The position idle gear shaft may connect to the bevel gear 152, e.g., via welding, spline or keyed engagement, or machine screws, to complete a mechanical position feedback coupling therebetween. The absolute position encoder 154 is communicatively connected to the motor unit CPU 165 and to a PCB mounted to a PCB adaptor 162 using a wired connection, e.g., to exchange signals with and be power by the microcontroller.

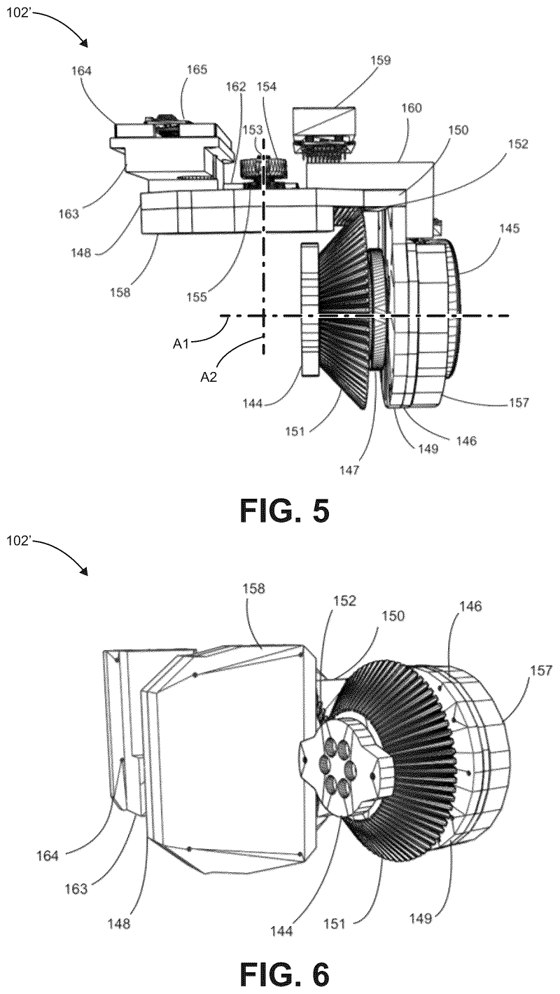

With reference next to FIG. 5, the foundational motor support structure of the motor unit 102′ is shown having an L-shaped plan-view profile in which the first motor plate A 148, third motor plate C 150, and gear shell 158 are mutually parallel with each other and substantially orthogonal to the adaptor 146, second motor plate B 149, and wire channel cover 157, which are mutually parallel with each other. With the arrangement, the hip/shoulder motor 145 rotatably attaches to the hip/shoulder motor plate adaptor 146, e.g., via splined engagement between an externally toothed hub of the motor 145 and an internally toothed bore in the adaptor 146. The motor plate adaptor 146 and, thus, the motor 145 and cover 157 is then mounted to the right-angle motor plate B 149.

Operating as a gear-reduction device to selectively increase motor torque, a metal hip/shoulder harmonic drive unit 147 is mounted to the hip/shoulder right angle plate B 149 and both physically and drivingly interposed between the motor unit 145 and the bevel gear 151. As best seen in FIG. 7, a keyed motor shaft of the hip/shoulder motor 145 passes through the adaptor 146 and motor plate B 149, and inserts via a keyed bore hole of the harmonic drive unit 147. During operation of the hip/shoulder motor 145, the motor shaft will rotate the harmonic drive unit 147, which concomitantly reduces the motor's rotational output speed while increasing the motor's torque output. The motor-driven position bevel gear 151 is drivingly connected to the hip/shoulder harmonic drive 147 and, via the harmonic drive 147, to the motor 145. Non-limiting examples of suitable harmonic drive units that may be employed for the modular motor unit 102′ include the FB-2, FR-2, and FD-2 pancake-type and cup-type harmonic drive assemblies manufactured by HARMONIC DRIVE® of Beverly, MA.

The herein-described harmonic drive units may function to provide a gear-ratio reduction of an electric motor to thereby increase a motor torque output of the electric motor. A harmonic drive unit may include a circular spline with internal teeth that mesh with external teeth on a flexspline. The flexspline may have fewer teeth and, consequently, a smaller effective diameter than the circular spline. A wave generator, which may be elliptical in shape, acts as a link that rotates within the flexspline, causing it to mesh with the circular spline progressively at diametrically opposite points. Receiving motor torque from the motor, the wave generator acts as the harmonic drive unit's mechanical input that rotates (e.g., in a clockwise direction) with the motor shaft while the circular spline is fixed in place. The flexspline, which may operate as the harmonic drive unit's mechanical output, will rotate inside the circular spline at a slower rate (e.g., in a counterclockwise direction). Additional, non-limiting information about harmonic drive units may be found, for example, in U.S. Pat. Nos. 7,178,427 B2 and 9,353,804 B2, both of which are incorporated herein by reference in their entireties and for all purposes.

The motor-driven position bevel gear 151, which rotates on a first axis A1 (horizontal in FIG. 5), makes precise tooth-mating contact with the idle position bevel gear 152, which rotates on a second axis A2 (vertical in FIG. 5) that is substantially perpendicular to the first axis A1. The idle position bevel gear 152 is attached via the idle gear shaft 153 to the absolute position encoder 154, and the encoder 154 is mounted on top of an encoder hub 155 (FIG. 5) that is rigidly secured to the right-angle plate A 148, e.g., using machine screws. This idle gear shaft 153 passes through a shaft bore in the right-angle motor plate A 148 and a central bore of the encoder hub 155; the absolute position encoder 154 is secured to the shaft 153 to read a real-time motor position of the motor 145. Signals indicative of the motor position are output via the encoder 154 to the motor unit CPU 165 to facilitate operation of the motor unit 102′.

To transmit motor torque from the modular hip/shoulder motor unit 102′ to one of the hip/shoulder adaptors 25, 93 of the exoskeleton 10, each motor unit 102′ includes a motor attachment plate (or “motor shaft hub”) 144 that is drivingly connected to the electric motor 145 via both the driven position bevel gear 151 and the harmonic drive 147. The motor attachment plate 144 serves as the interface site at which the motor unit 102′ drivingly connects to the hip assembly 14 or shoulder assembly 37, e.g., provisioning robotic actuation for a hip or shoulder joint on a hybrid exoskeleton containing a matching attachment site. With the motor 145 drivingly connected to the adaptors 25, 93 to selectively rotate the corresponding joint thereof, the motor's foundational support structure may immovably mount by way of right-angle motor plate A 148 and bracket 99 to the corresponding hip/shoulder assembly 14, 37. FIG. 6 of the drawings provides a perspective-view of a hip/shoulder assembly-side contact face of the motor attachment plate 144 and the fastener holes through which are received threaded fasteners for coupling the motor attachment plate 144 to the hip/shoulder adaptors 25, 93.

The hip/shoulder motor unit 102′ of FIGS. 3-6 is shown partially exploded in FIG. 7 to more clearly indicate how the constituent parts of the motor unit 102′ directly and indirectly interconnect with one another. By way of example, this Figure illustrates how the CPU adaptor bracket 164 mounts the hip/shoulder motor unit CPU 165 to the microcontroller plate 163, and how the hip/shoulder PCB adaptor 162 and microcontroller plate 163 mount to an outboard face of the first right-angle motor plate A 148 opposite that of the gear 152. This view also details how the hip/shoulder motor attachment plate 144 mounts onto the first bevel gear 151, the bevel gear 151 couples to the harmonic drive 147, and the harmonic drive 147 couples to the motor 145. It can also be seen how the motor plate adaptor 146 fits between the motor 145 and second right-angle motor plate B 149, the motor wire channel cover 157 fits onto the motor 145, and the idle position gear outer shell 158 fits over part of the idle position bevel gear 152. FIG. 7 also shows how the hip/shoulder position idle gear shaft 153 connects the hip/shoulder idle position bevel gear 152 to the encoder flanged bearing 156, absolute encoder 154, and encoder hub 155 for absolute position sensing.

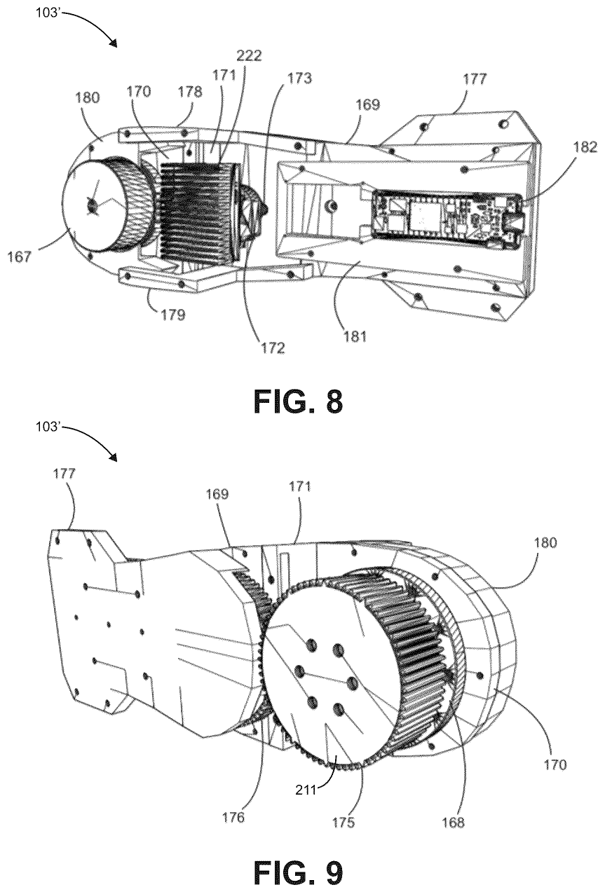

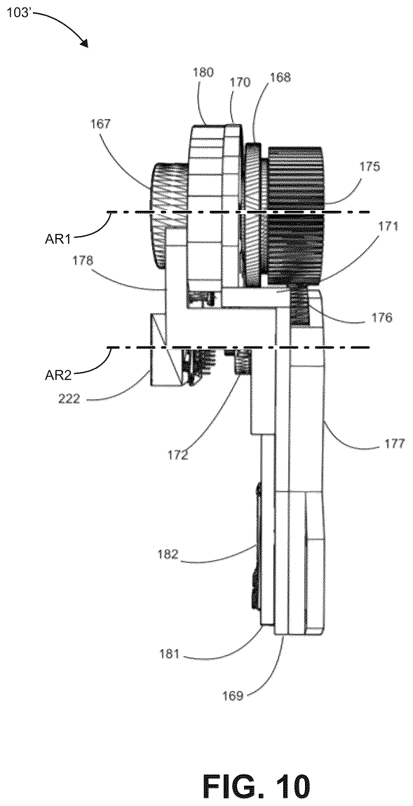

Turning next to FIG. 8, there is shown an example of a modular elbow/knee motor unit 103′ that may be adapted for use as the knee motor unit modules 103 and/or the elbow motor unit modules 105 of FIG. 2 (e.g., wherein left elbow/knee motor units may be mirror images of the right elbow/knee motor units). In the illustrated example, the modular motor unit 103′ employs a first staggered motor plate A 169 that is securely attached to a second staggered motor plate B 170 to collectively define a foundational support structure onto which is mounted many of the motor unit's constituent internal parts. The first and second staged motor plates 169, 170 may be rigidly joined together by a third staggered motor plate C 171, for example, via machine screws, such that the motor plates 169, 170 are substantially parallel to each other and substantially orthogonal to the motor plate C 171, as best seen in FIG. 10. It may be desirable that the first and second motor plates 169, 170 be made from an FRP material to help minimize the motor unit's weight, whereas the third motor plate 171 may be made of steel or other rigid material to increase the foundational support structure's strength and durability. A protective and weather-resistant outer housing, such as a motor unit cover (see, e.g., FIGS. 33 and 37 of '425 application), may cover the constituent parts of the motor unit 103′.

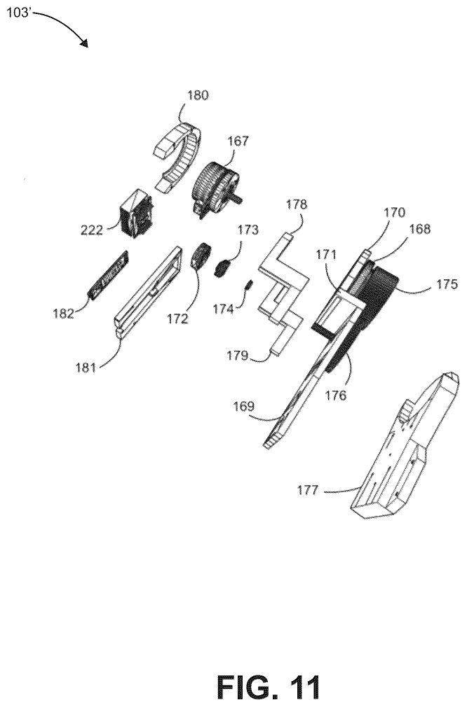

To stabilize and reinforce the staggered motor plates 169, 170, 171, the motor unit 103′ of FIGS. 8-11 may employ one or more zigzag-shaped motor plate rails (or “ligaments”) 178 and 179 that may rigidly mount to and sit substantially flush against the first and third motor plates 169, 171. Located at a distal (first) longitudinal end of the motor unit 103′ is an electric hip/shoulder motor 167, which may be in the nature of a brushless DC motor and may be at least partially circumscribed by a C-shaped motor wire channel cover 180. Both the electric motor 167 and wire channel cover 180 may be rigidly secured onto the second motor plate 170 via machine screws. As best seen in FIGS. 10 and 11, the motor wire channel cover 180 may be sandwiched between and held in place by the second motor plate 170 and the two stabilizing ligaments 178, 179. With this arrangement, the electric motor 167, ligaments 178, 179, and cover 180 are all located on a first (forward or front) side of the foundational support structure. Although differing in appearance, it is envisioned that any of the features and options described above with reference to the motor unit 102′ of FIGS. 3-7 may be incorporated, singly or in any combination, into the motor unit 103′ of FIGS. 8-11, and vice versa. To that end, like components from the various views may share any of the herein described features related to that component even if not reiterated in the discussion of that component.

Also located at the distal longitudinal end of the motor unit 103′ is an electronic PCB package with heat sink and motor driver 222 that controls a power feed to and a resultant variable speed of the elbow/knee motor 167. The PCB package and motor driver 222 may be mounted onto the first staggered motor plate A 169, located between the two stabilizing ligaments 178, 179 and above an electronic PCB absolute position encoder 172. The absolute position encoder 172 may be mounted to an elbow encoder hub 173, e.g., using machine screws, such that the encoder 172, encoder hub 173, and encoder flanged bearing 174 are located between the motor driver 222 and the motor plate 169. In accord with the illustrated example, the elbow/knee motor 167 is communicatively connected to, e.g., via electrical wires, and controlled by the elbow motor driver 222; this wired connection may be concealed by the motor wire channel cover 180.

Located at a proximal (second) longitudinal end of the motor unit 103′, opposite that of the motor 167, is an elbow/knee motor unit CPU 182 that is mounted via a CPU adaptor bracket 181 to the motor plate 169, e.g., using machine screws. The elbow/knee motor unit CPU 182 receives and processes position data signals output from the absolute position encoder 172; using these signals, the motor unit CPU 182 controls the PCB package and motor driver 222 and thereby governs operation of the motor 167. Mounted onto a second (rearward or back) side of the foundational support structure, opposite that of the motor unit CPU 182, is an idle gear outer shell 177 that substantially covers an idle gear 176. In this example, the idle gear outer shell 177 functions as a modular attachment site or interface at which the motor unit 103′ detachably mounts with the knee attachment assembly 30, forearm attachment assembly 108, or other joint that needs assistance or robotic actuation. While machine screws are repeatedly discussed herein as an option for structurally joining various components, it is envisioned that other suitable fasteners, adhesives, connectors, and joining techniques may be employed to attach constituent parts of the motor units.

FIG. 9 of the drawings provides a perspective view of the second (rearward/back) side of the motor unit 103′ to more clearly see how the first staggered motor plate A 169 is physically joined to the second staggered motor plate B 170 by the third staggered motor plate C 171. Located on the second side of the motor unit 103′ is a motor-driven position (first) spur gear 175 that is meshingly engaged with a gear-driven idle position (second) spur gear 176. In accord with this example, a keyed shaft of the electric motor 167 passes through a complementary bore hole in the second staggered motor plate B 170 and into a bore with keyway of an elbow/knee harmonic drive unit 168. This harmonic drive unit 168 is mounted to a second (rearward/rear) face of the second staggered motor plate B 170, e.g., via machine screws, and creates a gear reduction that increases an output torque of the electric motor 167. The motor-driven position spur gear 175 is attached to the harmonic drive unit 168, e.g., using machine screws, to rotate in unison therewith. Spur gear 175 is operatively connected to the idle position spur gear 176 to transmit thereto rotational forces for positional feedback. The spur gear 176 may be press-fit connected to the absolute position encoder 172 to such that the encoder 172 may determine a real-time or near real-time angular position of the motor 167. Each motor unit 103′ may also include a motor attachment plate 211 that is mounted to an outboard face of the spur gear 175 and drivingly connects to the electric motor 167 via both the spur gear 175 and the harmonic drive unit 168. Like the motor attachment plate 144, the motor attachment plate 211 serves as the interface site at which the motor unit 103′ drivingly connects to the elbow/knee assembly (e.g., via bolts received by bolt holes in the motor attachment plate).

Turning next to FIG. 10, there is shown a plan-view illustration of the representative motor unit 103′ of FIGS. 8 and 9. This view shows the manner in which the three motor plates 169, 170, 171 cooperate with the stabilizing ligaments 178, 179 to generally surround and protect the encoders 172. In contrast to the bevel gears 151, 152 of motor unit 102′, the motor-driven position spur gear 175 rotates on a first rotational axis AR1 (FIG. 10) while making precise tooth-mating contact with the gear-driven idle spur gear 176, which rotates on a second rotational axis AR2 that is substantially parallel to and spaced from the first rotational axis AR1. Similar to the bevel gears 151, 152, it may be desirable that the first spur gear 175 have a larger diameter and a larger axial width than that of the second spur gear 176. It may also be desirable that each of the gears 151, 152, 175, 176 be rotatably mounted to a respective one of the motor plates such that the gears are axially offset from each other.

The elbow/knee motor unit 103′ of FIGS. 8-10 is shown partially exploded in FIG. 11 to more clearly indicate how the constituent parts of the motor unit 103′ directly and indirectly interconnect with one another. By way of example, this Figure illustrates how the CPU adaptor bracket 181 mounts the hip/shoulder motor unit CPU 182 to an outboard face of the first staggered motor plate A 169 opposite that of the idle gear 176 and the idle gear outer shell 177. This view also details how the motor attachment plate 211 mounts onto the first spur gear 175, the spur gear 175 couples to the harmonic drive 168, and the harmonic drive 168 couples to the motor 167. It can also be seen how the idle gear outer shell 177 mounts onto the first staggered motor plate A 169 to cover the idle gear 176, and how the wire channel cover 180 mounts onto the second staggered motor plate B 170 to cover the motor 167. FIG. 11 also shows how the idle gear shaft connects the spur gear 176 to the encoder flanged bearing 174, absolute encoder 172, and encoder hub 173 for absolute position sensing.

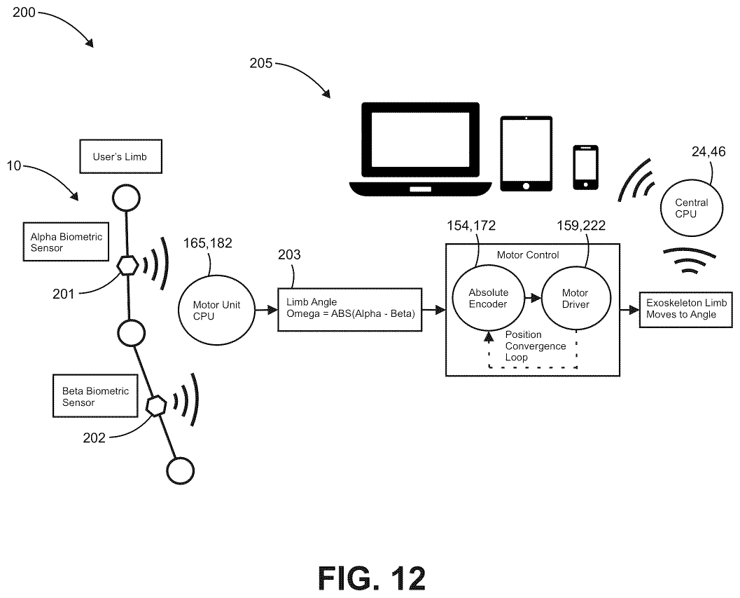

FIG. 12 provides a diagrammatic illustration of a representative wireless biometric sensor-to-motor unit control system and method, collectively designated as 200. In this example, an alpha biometric sensor 201 and a beta biometric sensor 202 collect biometric measurements from a user wearing the exoskeleton system 10 of FIGS. 1 and 2. When one of the motor unit CPUs 165, 182 subscribes to the wireless transmission of sensor data from one or both biometric sensors 201, 202, it may responsively calculate a limb joint angle omega, as indicated at process block 203.

Omega=|alpha−beta|

After the calculation of omega, the motor unit CPUs 165, 182 use the limb joint angle as an input for motor control. An absolute position encoder 154, 172 determines a current position of an electric motor 145, 167; the motor unit CPU 165, 182 transmits command signals to the motor driver 159, 222 to move the motor 145, 167 in a direction corresponding to where is the omega set point. This process may systematically repeat until a position convergence is achieved. A result may include real-time movement of an exoskeleton limb to assist the user's action. An output movement signal may be sent via wireless transmission to a central CPU (e.g., lower body subsystem CPU 24 or upper body subsystem CPU 46) for processing. Commensurate data may be concurrently sent via wireless transmission from the central CPU to an IoT device, such as a phone, tablet, computer app, etc., (collectively 205 in FIG. 12), e.g., for data display and logging.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the disclosure expressly includes any and all combinations and subcombinations of the preceding elements and features.

What is claimed:

1. A motor unit for an exoskeleton system having an exoskeleton frame with a joint assembly configured to attach to an appendage of a user, the motor unit comprising:
a motor support structure including a first motor plate rigidly attached to a second motor plate, the first motor plate being configured to mount to the joint assembly;
an electric motor mounted to the second motor plate and operable to produce a motor output torque at a motor output speed;
a harmonic drive unit drivingly connected to the electric motor and operable to modify the motor output speed and the motor output torque of the electric motor; and
a motor attachment device drivingly connected to the harmonic drive unit and configured to drivingly connect to the joint assembly and thereby transmit thereto the modified motor output torque at the modified motor output speed from the harmonic drive unit.

2. The motor unit of claim 1, further comprising:
a first gear drivingly connected to the harmonic drive unit;
a second gear rotatably attached to the first motor plate and meshingly engaged with the first gear; and
a rotational position encoder operatively connected to the second gear and operable to determine therefrom a rotational position of the electric motor.

3. The motor unit of claim 2, wherein the first gear is interposed between and coaxial with the harmonic drive unit and the motor attachment device.

4. The motor unit of claim 3, wherein the harmonic drive unit is interposed between and coaxial with the first gear and the electric motor.

5. The motor unit of claim 2, wherein the first gear is a first spur or bevel gear and the second gear is a second spur or bevel gear.

6. The motor unit of claim 2, wherein the first gear rotates on a first axis and the second gear rotates on a second axis spaced from and substantially orthogonal or substantially parallel to the first axis.

7. The motor unit of claim 1, further comprising a motor plate reinforcement rail rigidly attached to the motor support structure and joining the first motor plate to the second motor plate.

8. The motor unit of claim 7, wherein the motor plate reinforcement rail includes first and second L-shaped rails each having a respective first end rigidly attached to and abutting the first motor plate and a respective second end rigidly attached to and abutting the second motor plate.

9. The motor unit of claim 7, wherein the motor plate reinforcement rail includes first and second zigzag-shaped rails each having a respective first end rigidly attached to and abutting the first motor plate and a respective second end rigidly attached to and abutting the second motor plate.

10. The motor unit of claim 1, wherein the electric motor, the harmonic drive unit, and the motor attachment device are coaxial with one another on a first axis of rotation.

11. The motor unit of claim 1, wherein the motor support structure further includes a third motor plate interposed between and rigidly attaching the first motor plate to the second motor plate.

12. The motor unit of claim 11, wherein the first motor plate is substantially parallel or substantially orthogonal to the second motor plate, and wherein the third motor plate is substantially orthogonal to the first motor plate and/or the second motor plate.

13. The motor unit of claim 1, further comprising a motor unit housing rigidly attached to the motor support structure and containing therein the electric motor.

14. The motor unit of claim 1, wherein the motor attachment device includes a substantially flat plate drivingly attached to the harmonic drive unit via a first gear to rotate in unison therewith.

15. An exoskeleton system comprising:
an exoskeleton frame with a joint assembly configured to attach to an appendage of a user; and
a motor unit removably attachable to the joint assembly, the motor unit including:
a motor support structure including a first motor plate rigidly attached to a second motor plate, the first motor plate being removably mounted to the joint assembly;
an electric motor mounted to the second motor plate and operable to produce a motor output torque at a motor output speed;
a harmonic drive unit drivingly connected to the electric motor and operable to modify the motor output speed and the motor output torque of the electric motor; and
a motor attachment plate drivingly connected to the harmonic drive unit and removably drivingly connected to the joint assembly to transmit thereto the modified motor output torque at the modified motor output speed from the harmonic drive unit.

16. A method of assembling a motor unit for an exoskeleton system, the exoskeleton system having an exoskeleton frame with a joint assembly configured to attach to an appendage of a user, the method comprising:
assembling a motor support structure including rigidly attaching a first motor plate to a second motor plate, the first motor plate being configured to mount to the joint assembly;
mounting an electric motor to the second motor plate, the electric motor being operable to produce a motor output torque at a motor output speed;
drivingly connecting a harmonic drive unit to the electric motor, the harmonic drive unit being operable to modify the motor output speed and the motor output torque of the electric motor; and
drivingly connecting a motor attachment device to the harmonic drive unit, the motor attachment device being configured to drivingly connect to the joint assembly and thereby transmit thereto the modified motor output torque at the modified motor output speed from the harmonic drive unit.

17. The method of claim 16, further comprising:
drivingly connecting a first gear to the harmonic drive unit;
rotatably attaching a second gear to the first motor plate;
meshingly engaging the second gear with the first gear; and
connecting a rotational position encoder to the second gear, the rotational position encoder being operable to determine a rotational position of the electric motor.

18. The method of claim 17, further comprising interposing the first gear between and coaxial with the harmonic drive unit and the motor attachment device.

19. The method of claim 16, further comprising rigidly attaching a plurality of motor plate reinforcement rails to the motor support structure such that the reinforcement rails join the first motor plate to the second motor plate.

20. The method of claim 16, further comprising interposing a third motor plate between and rigidly attached to the first motor plate and the second motor plate.
